(19) United States
(12) Patent Application Publication
(10) Pub. No.: US 2008/0015896 A1
(43) Pub. Date: Jan. 17, 2008

(54) Hospital Pay for Performance Based on Gain-Sharing

(76) Inventor: James Reynolds, New York, NY (US)

Correspondence Address: Eugene Molinelli;Evans & Molinelli PLLC, P. O. Box 7024, Fairfax Station, VA, 22039, US

(21) Appl. No.: 11/770,711

(22) Filed: Jun. 28, 2007

Related U.S. Application Data
(60) Provisional application No. 60/831,158, filed on Jul. 14, 2006.

(51) Int. Cl. G06Q 50/00; G06Q 40/00

(52) U.S. Cl. 705/2; 705/39

(57) ABSTRACT

Techniques for determining payment to a particular health care facility for health care delivery include determining target adverse results rate (ARR) for treatment of a particular range of patient health conditions (RHC). A first actual cost is determined for treatment of the RHC during a first time interval. A first ARR during the first time interval is determined. A second actual cost is determined for treatment of the RHC during a second time interval. A second ARR during the second time interval is determined. It is then determined whether the second actual cost prorated per case (CPC) is less than the first actual CPC and whether the second ARR is not farther from the target ARR. If so, then payments per case to the facility for the RHC are reduced based on a first fraction of the difference between the first actual CPC and the second actual CPC.

### CROSS-REFERENCE TO RELATED APPLICATIONS

This application claims benefit of Provisional Appln. 60/831,158, filed Jul. 12, 2006, the entire contents of which are hereby incorporated by reference as if fully set forth herein, under 35 U.S.C. §119(e).

### BACKGROUND OF THE INVENTION

1. Field of the Invention

The present invention relates to determining payments for care provided in healthcare facilities by related physicians based on objective measures of performance.

2. Description of the Related Art

Rising health care costs are a significant factor in the economy. Employers are faced with rising costs of premiums provided as part of employee benefits packages. Employees without health care coverage benefits are significant in number and are less likely to obtain that benefit as costs rise. Those without coverage can not afford to pay a full share of their costs when care is provided to them; and the excess costs are passed on to those with coverage and to the government, which increases costs on those who pay taxes, and employers. Slowing or reversing this spiral of costs is advantageous.

Purchasers of health care, especially bulk purchasers such as insurance carriers and large corporations, are attempting to control rising costs by tightening their payment policies. The current policies generally pay doctors more the longer their patients stay in their care, such as in a hospital, while generally rewarding hospitals for discharging patients sooner. The doctor's and hospitals interests are thus not aligned. Reducing the doctor's influence on decisions about the duration of a patient's hospital stay threatens the quality of patient care and might increase patient complication rates among other adverse outcomes. Yet, erring in the direction of longer hospital stays increases the total health care delivery costs. This situation has been called a “toxic payment” system by the Institute of Medicine (IOM).

New payment methods that tie financial incentives to performance, service volume, and intensity are being introduced. These arrangements, often called “Pay for Performance (P4P),” are primarily agreements between third party payers, such as health plans and employers, and either hospitals or physicians, not involving both. While various P4P structures currently exist across the country, they each share a framework that ties financial rearwards to measurements and results. The practical impact of P4P is still uncertain, largely as a consequence of the conflicting financial interests of the parties involved: payers, hospitals and physicians.

What are needed are techniques to reduce costs without increasing patient complication rates, mortality rates, readmissions for related problems and other adverse outcomes.

### SUMMARY OF THE INVENTION

Techniques are provided for determining payment to a particular health care facility for health care delivery.

In a first set of embodiments, a method includes determining target adverse results rate for treatment of a particular range of patient health conditions. A first actual cost at the particular health care facility is determined for treatment of the particular range of patient health conditions during a first time interval. A first adverse result rate at the particular health care facility after treatment for the particular range of patient health conditions during the first time interval is determined. A second actual cost at the particular health care facility is determined for treatment of the particular range of patient health conditions during a second time interval after an end of the first time interval. A second adverse result rate at the particular health care facility after treatment for the particular range of patient health conditions during the second time interval is determined. It is then determined whether the second actual cost prorated per case is less than the first actual cost prorated per case and whether the second adverse result rate is not farther from the target adverse result rate than is the first adverse result rate. If so, then future payments per case to the particular health care facility for treatment of the particular range of patient health conditions after the second time interval are reduced based on a first fraction of the difference between the first actual cost prorated per case and the second actual cost prorated per case.

In other sets of embodiments, a computer readable medium or an apparatus performs one or more steps of the above method.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow diagram that illustrates a method for determining payments to a facility for healthcare, according to an embodiment;

FIG. 2 is a flow diagram that illustrates a method for performing one step of the method depicted in FIG. 1, according to an embodiment;

FIG. 3 is a flow diagram that illustrates a method for performing another step of the method depicted in FIG. 1, according to an embodiment;

FIG. 4A is a graph that illustrates cost reductions with time, according to two embodiments with per-case rates;

FIG. 4B is a graph that illustrates reductions in payments per case with time, according to two embodiments with per-case rates;

FIG. 5A is a graph that illustrates cost reductions with time, according to two embodiments with per diem rates at the outset;

FIG. 5B is a graph that illustrates reductions in payments per case with time, according to two embodiments with per diem rates at the outset; and

FIG. 6 is a block diagram that illustrates a computer system upon which an embodiment of the invention may be implemented.

### DETAILED DESCRIPTION

Techniques are described for determining payments for healthcare. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Some embodiments of the invention are descried below in the context of payments to a hospital and doctors for conditions and procedures categorized by Medicare and paid by insurers. However, the invention is not limited to this context. In other embodiments, payments are determined to the same or different health care facilities, such as hospitals, clinics and doctor's offices, by the same or different payers, such as corporations or insurers or patients groups, for healthcare delivered by doctors or other practitioners, such as medics and nurses, for the same or different categories of procedures or patient conditions.

### 1. Overview

Applicants realized that there is great potential for cost savings because the best practices often lead to favorable results with fewer complications and thus fewer costs. Furthermore, Applicants realized how to align the financial interests of doctors with those of the hospital by a form of gain sharing. Applicants have taken this further so that payers also benefit from sustainable cost savings. Applicants have included considerations of the patients' goals for healthcare by maintaining the same or better levels of adverse results during all time periods of cost savings. Thus embodiments of Applicants' invention consider all the major stakeholders: patient, practitioner, healthcare facility, and healthcare payer.

Evidence indicates that as healthcare providers improve the quality of clinical outcomes, associated case costs are often reduced. CareScience, a clinical information system and data repository, which compares a hospital's severity-adjusted clinical and cost outcomes, shows that there is generally a 10 to 20 percent improvement for both quality and cost from the average performers to those in the top 15th (i.e., 85^{th}) percentile. Thus, if practitioners can sufficiently improve the quality of their patient outcomes, there will often be a commensurate reduction in the case cost of care. Embodiments of Applicants' invention leverage such reduced case cost to provide financial incentives to practitioners, facilities and payers, while providing maintained or improved outcomes to the patients.

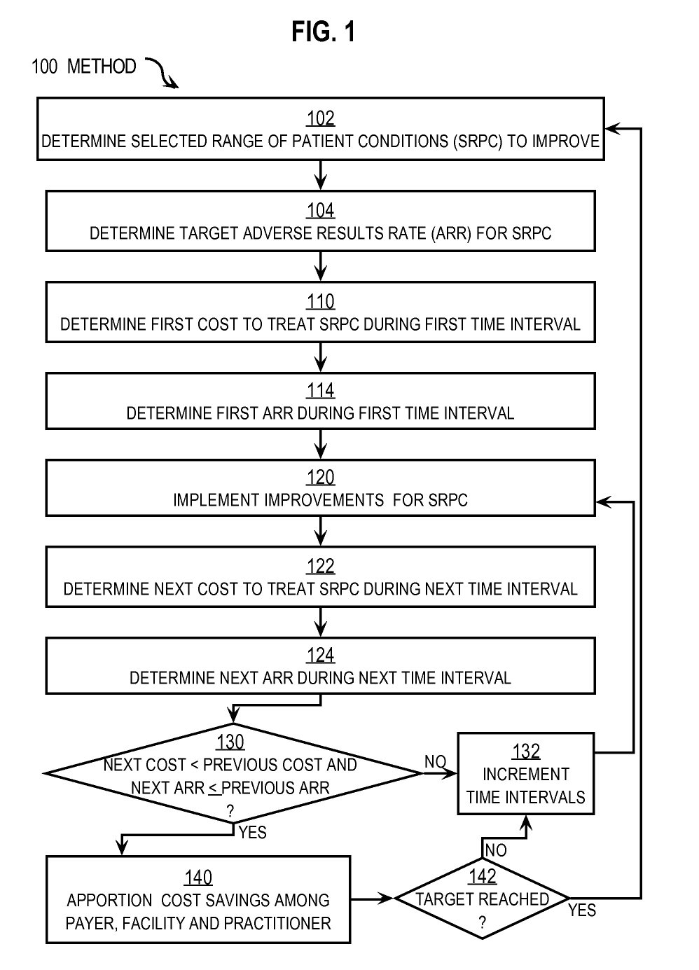

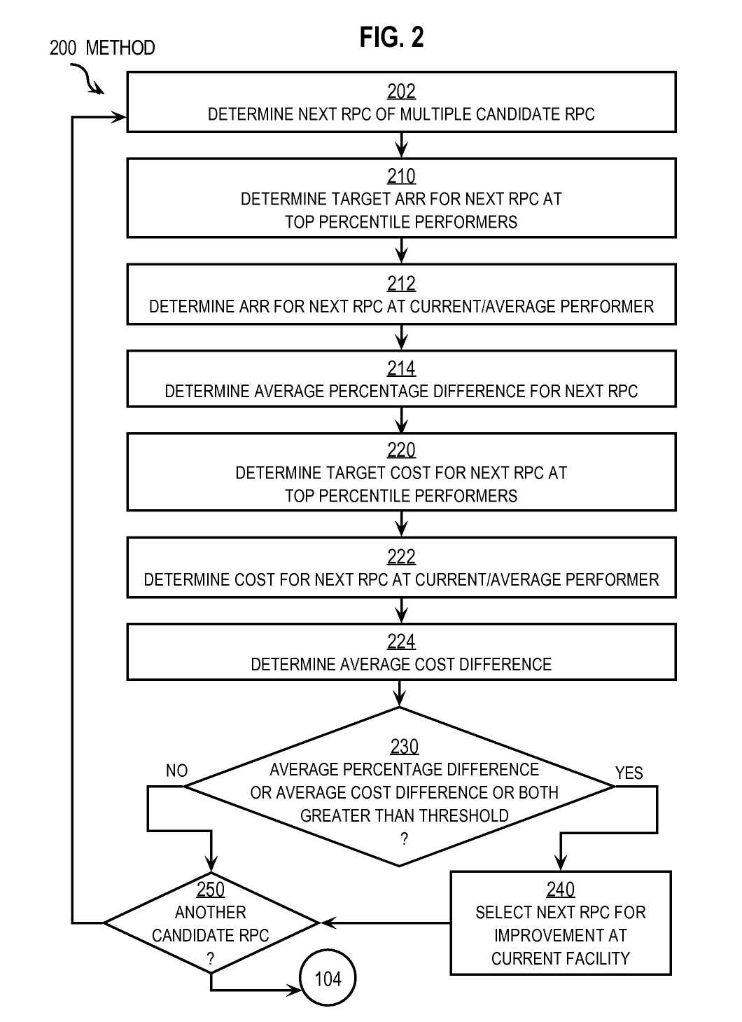

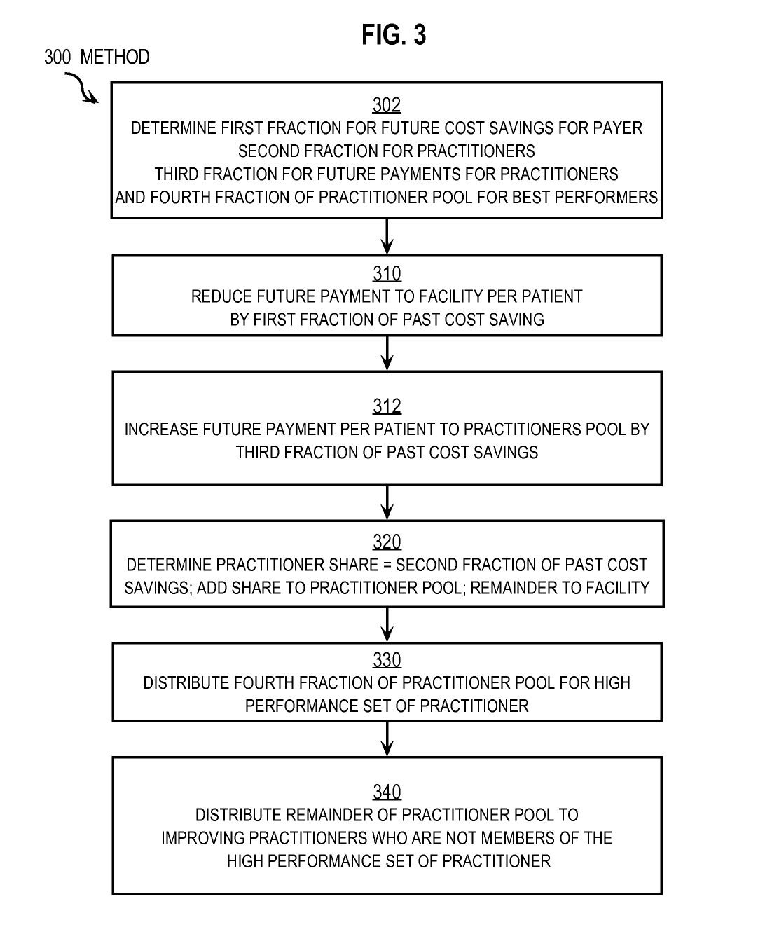

FIG. 1 is a flow diagram that illustrates a method 100 for determining payments to a facility for healthcare, according to an embodiment. Although steps in FIG. 1 and subsequent flow charts, FIG. 2 and FIG. 3, are shown in a particular order for purposes of illustration, in other embodiments, one or more steps may be performed in a different order or overlapping in time, in series or in parallel, or one or more steps may be omitted or added, or changed in some combination of ways.

In step 102, a range of patient conditions is selected for improved cost and outcome. More details on how the range of conditions is selected are described below with reference to FIG. 2.

In general, as is well known in the art, a patient condition can be categorized using a code. For example a Current Procedural Terminology (CPT) code, or an International Classification of Diseases (ICD-9-CM) code, or a Diagnosis Related Group (DRG) code can be used to categorize a patient's condition. All Payer Refined DRGs (APR-DRGs) assign four levels of severity of illness to about 300 basic patient conditions as a way to compare outcomes and costs for homogenous groupings of patient situations (also called severity corrected conditions). ICD-9-CM codes are universal codes that are recognized by all insurance companies, hospitals and physicians. These codes are used by the insurance companies and providers to classify the type of care a patient receives. Insurance companies use this code to determine payment and reimbursement to the hospital for an individual claim. The hospital and physicians use the ICD-9-CM code to indicate the type of diagnosis or procedure(s) used to treat the patient. A DRG is only assigned to patients treated in an inpatient hospital service. DRGs are groupings of diagnoses and/or procedures that are used by Medicare and most insurance companies to classify the type of inpatient care provided, for the purposes of payment. Insurance companies often use the DRG code, or the length of the inpatient stay multiplied by a per diem rate, to determine payment for an individual claim. Alternatively an insurer may pay hospital claims based on a percentage of the hospital's charges.

In the illustrated embodiments, the code, such as the DRG, is augmented through the use of a severity indicator of some kind for each kind of outcome and cost—that is, an expected value which can be compared with the actual value. The severity indicator accounts for different expected outcomes for patients with the same DRG, or other, category. Severity of patient conditions is a measure of changes in expected outcome due to complicating factors in the patient including other collateral conditions suffered by the patient, and age, weight and conditioning of the patient.

In some embodiments, the range of patient conditions refers to a particular procedure, such as a coronary bypass graft surgery, that is used to treat one or more patient conditions.

A range of patient conditions is therefore often expressed as a code with a one or more severity values. For embodiments using APR-DRGs, one of four severity values is assigned to each code. For example, a range of patient conditions is expressed by DRG 109 Coronary Artery Bypass Graft surgery (CABG) without Percutaneous Coronary Interventions (also known as Balloon Angioplasty). This refers to a range of patient conditions that can be treated by the CABG procedure. It is assumed, for purposes of illustration, that this example represents patient condition range: DRG 549 (expressed herein as DRG549).

In step 104, a target adverse results rate (ARR) is determined for the range of patient conditions selected. Any method may be used to determine the adverse results rate. In some embodiments, the ARR is a weighted average of the mortality rate and the complications rate. The mortality rate is the number of deaths per 100 procedures, expressed as a percentage. The complications rate is the number of cases in which the patient's condition deteriorates per 100 procedures, also expressed as a percentage. This is the percentage of people who have complications, such as an infection or organ malfunction, after a procedure or treatment. For simplicity, it is assumed in the illustrated embodiment that the ARR is equal to the mortality rate.

Any method may be used to determine the target ARR. For purposes of illustration, it is assumed that the target ARR is the published ARR of the top 15^{th} percentile (i.e., the 85^{th} percentile) actual performers (as used herein, a performer is a facility and practitioner combination). For purposes of illustration it is assumed that the 85^{th} percentile actual performers have an ARR of 1.4% or less for DRG549.

In step 110, the actual cost to treat patients with the selected range of patient conditions is determined for some base interval of time. In some embodiments, the cost is the total cost associated with all such patients, including the indirect costs for the facility, and for staffing the hospital with maintenance workers, administrators, and providing utilities such as heating, cooling, light, whether a bed is occupied or not. In some embodiments, only direct costs associated with such patients are determined, including food and medications and other consumables given to those patients, running equipment only when treating those patients, and minutes of caregiver time expended on those patients, and excluding the indirect costs. The base interval of time is a time long enough to determine statistically meaningful costs per case per day of stay using current procedures. In an illustrated embodiment, the base interval is one year, such as the most recently passed year for which accounting data is available to determine cost.

During step 110, the number of cases of patients with the selected range of patient conditions is also determined for the base interval of time, so that total or direct cost per case can be determined. The term case is used in some embodiments to distinguish among multiple occurrences of the same condition or procedure in the same patient over the same time period. For example, patient A may have a CABG procedure early in an interval and then have another CABG procedure later in the same interval. These are two cases even though only one patient. As used herein, the term cost per patient is used interchangeably with the term cost per case to indicate the cost for each occurrence of the condition in each patient.

For purposes of illustration, it is assumed that 700 patients with DRG549 are treated during a base year for a total cost of $15,745,000 yielding an average case cost of $22,493.

In step 114, the actual adverse results rate is determined for the base time interval. For purposes of illustration it is assumed that the actual adverse results rate (ARR) for the base interval is higher than the target ARR. For example, it is further assumed that the average ARR for DRG549 is 3.3%.

In step 120, improvements are implemented for treatment of the selected range of patient conditions. In some embodiments, the facility makes improvements. In some embodiments, the practitioners make improvements. In some embodiments, both make improvements. The role of the hospital and its physicians is to identify opportunities to simultaneously improve clinical outcomes and reduce case costs. This which may drive up per diem costs because end-of-stay days that are less expensive might be eliminated. Both players may also make necessary investments in order to accomplish performance improvements. For hospitals, improvements are generally in the form of data systems enhancements to institute and track costs and adverse results and equipment used in the best practices protocols. For physicians, improvements are generally in the form of re-designing clinical protocols based on practices by the best performers and learning to adhere to new care policies. The cost of these changes is referred to as an opportunity cost and reflects the lost revenue to physicians as the physicians take time to make these adjustments instead of treating patients.

During step 122, actual cost to treat patients with the selected range of patient conditions is determined for the next interval of time. In some embodiments, the cost is the total cost associated with all such patients. In some embodiments, the cost is the direct cost. The next interval of time is a time long enough to determine statistically meaningful costs per diem and per case using the improved procedures. In an illustrated embodiment, the next interval is equal to the base interval and is one year. In some embodiments, during step 122, the number of cases of patients with the selected range of patient conditions is also determined for the next interval of time, so that a new total or direct cost per case can be determined.

For purposes of illustration, it is assumed that 700 patients with DRG549 are treated during each of the first three improved years for a total cost in the third year of $13,630,000 yielding an average cost of $19,472 per case. This corresponds to a total cost savings of $2,115,000 per year by the end of the third year.

In step 124, the actual adverse results rate is determined for the next time interval. For purposes of illustration it is assumed that the actual ARR for the next interval is somewhat lower than the initial ARR; but, is still higher than the target ARR. For example, it is further assumed that the average ARR for DRG549 is 2.5%.

In step 130, it is determined whether the actual cost per case for the next time interval is less than the actual cost per case for the base time interval and that the ARR for the next time interval is no worse than the ARR for the base time interval. If so, then there are cost savings to share and control passes to step 140. If not, then step 140 is skipped and control passes to step 132.

In step 132, the most recent next time interval becomes the new base time interval and a successive time interval after the most recent next time interval becomes the new next time interval. Control then passes back to step 120 to implement further improvements, if any, for the selected range of patient conditions for the successive time interval.

If it is determined, in step 130, that the actual cost per case for the next time interval is less than the actual cost per case for the base time interval and that the ARR for the next time interval is no worse than the ARR for the base time interval, then control passes to step 140. In the illustrated example, the actual cost per case for the first improvement year ($21,486) is less than the actual cost per case for the base year ($22,493) and that the ARR for the first improvement year (2.5%) is better than the ARR for the base year (3.3%), therefore control passes to step 140

In step 140, cost savings are apportioned among the payer and the facility and the practitioners according to a predefined sharing plan. In some embodiments, cost savings are apportioned among the payer and the facility but not to the practitioners. In the illustrated embodiment, actual savings are shared with the practitioners to especially motivate the practitioners to make the savings while still attaining ARR targets, as described in more detail in FIG. 3, while future per case savings are shared with the payers. In the illustrated example, $2,115,000 of actual third year savings for DRG549 are apportioned among the hospital and at least one of the doctors who performed this procedure during the third year. Anticipated continued future savings in cost of $3,021 per case for DRG549 are shared with the payer, in the illustrated embodiment. Cost inflation of the direct and indirect costs do not affect the calculation of cost savings from year to year. Cost inflation of various cost elements, such as the cost of medications, are added to future costs, according to an illustrated embodiment, as described in more detail below. Control then passes to step 142.

In step 142, it is determined whether the target adverse results rate has been reached. If not, control passes to step 132, described above, to increment the time intervals and back to step 120 to make further improvements. If it is determined, in step 142, that the target adverse results rate has been reached, then control passes back to step 102 to select another range of patient conditions to improve. For example, in the illustrated example, the 2.5% mortality rate achieved during the first year is not yet at the target of 1.4%, so further improvements are continued in the next year. In some embodiments, flow does not pass back to step 102, and the method ends with sustaining the improvements already made.

In some embodiments, step 102 is repeated to select a different range of patient conditions to improve before or instead of or in addition to being repeated after it is determined in step 142 that the target is reached for one selected range of patient conditions.

Sharing facility cost savings with physicians in step 140 under a predetermined plan defined under the auspices of the payer resolves the legal requirement to comply with the Civil Monetary Penalty law. Reporting on hospital and physician performance relies on objective performance levels agreed in step 104, which the hospital's clinical and financial reporting systems and data are competent to measure, and which can be made subject to independent audit. As participating physicians and hospital managers work to implement the agreed-upon redesign of selected care processes in step 120, the physicians only share in cost savings to the extent that such cost savings are actually realized and that clinical effectiveness is simultaneously maintained or improved.

The patients are protected because physicians only share in cost savings if agreed-upon targets for maintaining or improving clinical effectiveness are simultaneously achieved. In the example, a percentage of the $2,115,000 actual savings in the third year are distributed to doctors because mortality rates dropped from 3.3% to 1.4% in the third year while the savings were realized.

The payer faces virtually no downside risk because it need not make an investment in the improvements undertaken in step 120. Yet, if cost savings are achieved, during step 140, the payer reduces its per case future payment rate to the facility by an agreed-upon percentage of the amount of the hospital's actual case cost or readmission avoidance savings from the previous year. Note that a per case decrease may result in a per diem increase as lengths of stays diminish.

If it is determined that the total cost of readmissions within 90 days from discharge of patients treated for this range of patient conditions, and therefore the average cost to the payer for admissions and readmissions for this range of patient conditions is less than during the base time interval, then payment per case to the hospital is increased by about 50% of the amount of the readmission payments. This benefits the payer.

The hospital only agrees to accept reductions in its payment per case, in step 140, to the extent that its case costs are actually reduced, before cost inflation, as determined in step 130. As described in more detail with reference to FIG. 3, in some embodiments the facility's payment rate per diem increases from year to year, and its operating revenue margin also increases. In some embodiments the facility's payment rate per case increases from year to year as a result of reducing its readmissions within 90 days of discharge for relevant ranges of patient conditions In some embodiments, described in FIG. 3, the hospital is assured of recurring financial benefits as a result of an ongoing agreement with the payer to maintain the agreed-upon spread between the cost per case and the payment per case as long as the level of case costs is maintained from year to year, before cost inflation.

### 2. Example Embodiments

Further embodiments of the invention are described herein.

### 2.1 Selecting Range of Patient Conditions to Improve

FIG. 2 is a flow diagram that illustrates a method 200 for performing step 102 of the method depicted in FIG. 1, according to an embodiment. Thus method 200 is a particular embodiment of step 102 to determine which range of patient conditions (including certain procedures) are to be selected for improvement.

There are currently over 500 DRG categories which in many cases are split into medical diagnoses with or without complications. Each patient case may be severity using the CareScience method or, alternatively, using the APR-DRG classification system, which consists of four levels of severity for each of 300 DRGs. Thus there are a large number of potential ranges of patient conditions and procedures to consider for improvement. It is expected that at least ten percent of these provide a sufficient cost savings or clinical improvement opportunities to effectively align the incentives for doctors, facilities and payers. Those ten percent are desirably selected first.

In step 202, the next range of patient conditions (RPC) is selected as the current candidate RPC from all possible RPC. For example, DRG550 is selected as candidate range DRG550.

In step 210, a target adverse results rate is determined for the candidate range of patient conditions. Any measure may be used as an adverse results rate (ARR). As described above, in some embodiments the ARR is a weighted average of the mortality rate and the morbidity rate. In some embodiments, the ARR also includes a weighted or un-weighted mean of absolute or percent deviations from a compliance rate for a prescribed procedure, such as the number or percent of minutes deviation from a prescribed time to administer a drug or perform an operation, or the deviation in weight between a prescribed drug amount and an amount actually administered. The number and type of components of the measure of the adverse results rate depends on the focus of the condition or procedure and the agreement reached among stakeholders as to what components are objectively measurable, appropriate and acceptable. In an example embodiment for DRG549, the adverse results rate is the mortality rate.

In step 210, a target ARR is determined for the candidate range of patient conditions based on the ARR for the top percentile perfumers (as defined above a performer is a hospital physician combination). For example, it is assumed for purposes of illustration that the 85^{th} percentile performers for DRG549 experience a 1.4% mortality rate; and that the target ARR for DRG549 is the 1.4% mortality rate experienced by the 85^{th} percentile performers.

In step 212, an ARR for the candidate range of patient conditions at a particular facility is determined. In some embodiments the ARR for the candidate range of patient conditions at an average facility is determined. The same ARR definition used to define the target is used to define the particular or average facility ARR. It is assumed for purposes of illustration that the 50^{th} percentile performers for DRG549 experience a 3.0% mortality rate, while the 50^{th} percentile performers for DRG549 at a particular hospital where an embodiment is to be implemented is 3.3%.

In step 214 a clinical improvement value is determined based on a percentage difference between the target ARR and the particular facility ARR. When the ARR definition includes multiple components, the clinical improvement value is based on an average of the differences in percentages between corresponding components of the target ARR and particular facility ARR. In an example embodiment, the ARR is mortality rate; and the clinical improvement value is 58%. For purposes of illustration, it is assumed that the clinical improvement values for five ranges of patient conditions are given in Table 1. Here the clinical index for DRG549=(3.31−1.40)/3.31=58%.

TABLE 1
Example values of clinical improvement value and cost improvement value for
five ranges of patient conditions (M = million).

| | DRG | | | | | | | | | | | |
|---|---|---|---|---|---|---|---|---|---|---|---|---|
| | 549 | | 370 | | 372 | | 373 | | 489 | | combined | |
| Description | CABG | | Caesarean | | Vaginal | | Vaginal | | HIV with | | | |
| of range | | | Section | | delivery with | | delivery | | major | | | |
| | | | | | complicating | | without | | related | | | |
| | | | | | diagnosis | | complicating | | condition | | | |
| | | | | | | | diagnosis | | | | | |
| # cases | 700 | | 297 | | 402 | | 2344 | | 413 | | 4156 | |
| Clinical | 58% | | 16% | | 17% | | 11% | | 14% | | | |
| improvement | | | | | | | | | | | | |
| value | | | | | | | | | | | | |
| Cost | 13% | | 34% | | 44% | | 46% | | 22% | | | |
| improvement | | | | | | | | | | | | |
| value | | | | | | | | | | | | |
| Mean cost | $22,493 | | $9,014 | | $4,918 | | $3,224 | | $13,423 | | | |
| per case | | | | | | | | | | | | |
| Cost | $3,021 | | $3,100 | | $2,184 | | $1,471 | | $2,943 | | | |
| deviation | | | | | | | | | | | | |
| Potential cost | $2.115 | M | $0.921 | M | $0.878 | M | $3.448 | M | $1.215 | M | $8.577 | M |
| savings | | | | | | | | | | | | |

In step 220, a target cost is determined for the candidate range of patient conditions based on the cost for the top percentile perfumers. For example, it is assumed for purposes of illustration that the 85^{th} percentile performers for DRG549 incur a total cost of $18,472 and that the target cost for DRG549 is the cost experienced by the 85^{th} percentile performers.

In step 222, a cost for the candidate range of patient conditions at a particular facility is determined. In some embodiments, the cost for the candidate range of patient conditions at an average facility is determined. The same cost definition (e.g., direct cost or total cost per case) used to define the target is used to define the particular or average facility cost. It is assumed for purposes of illustration that the 50^{th} percentile performers for DRG549 at a particular hospital where an embodiment is to be implemented experience a mean cost of $22,493 per case.

In step 224 a cost improvement value is determined as a percentage difference between the target cost and the particular facility cost. In an example embodiment, the mean cost is $22,493 and the cost improvement value is 13% For purposes of illustration, it is assumed that the cost improvement values for five ranges of patient conditions are given in Table 1.

Table 1 also lists a mean cost per case, such as might be found at the average hospital and the cost deviation, which is the actual cost per case difference between the target and the particular facility. The product of the cost deviation and the number of cases, gives the total cost saving opportunity for the range of patient conditions. It is assumed for purposes of illustration that the remaining hundreds of patient ranges yield total cost savings less than the five presented in Table 1.

In step 230, it is determined whether the average ARR percentage difference or potential total cost savings or both exceed some threshold for selecting the candidate range of patient conditions. For example, in some embodiments, it is determined whether both the clinical improvement value and the potential total cost savings are above corresponding thresholds that are most significant for the participants. If not, then control passes to step 250.

In step 250, it is determined whether there is another candidate range of patient conditions to consider. If so, control passes back to step 202 to consider the next candidate range of patient conditions. If not, control passes to step 104, the next step in method 100 depicted in FIG. 1.

If it is determined, in step 230, that the average ARR percentage difference or potential total cost savings or both exceed some threshold for selecting the candidate range of patient conditions, then control passes to step 240. In step 240, a candidate range of patient conditions is selected for improvement at the particular facility. For example, one or more of the ranges of patient conditions in Table 1 is selected.

In some embodiments, step 240 includes forging agreement among two or more of the stakeholders of the percentages or fractions or formula to use to apportion any cost savings among the stakeholders and objective measures to use to determine whether the actual ARR is no farther than the original ARR from the target ARR, and which doctors may receive a portion of the actual savings achieved. The use of percentages, or fractions or formula, to apportion cost savings is described for some embodiments in FIG. 3. In some embodiments, step 302 of FIG. 3 is performed as part of step 240. The accounting and audit systems to track performance measures and costs are also agreed upon, in some embodiments. In some embodiments, step 240 includes determining and agreeing upon practitioner protocol changes or facility protocol and equipment changes, or both, to implement one or more improvements to better parallel the practices of the top performers. Control then passes to step 250 to determine whether any other candidate ranges of patient conditions remain to be considered.

### 2.2 Apportioning Actual and Future Cost Savings

FIG. 3 is a flow diagram that illustrates a method 300 for performing step 140 of the method depicted in FIG. 1, according to an embodiment. Thus method 300 is a particular embodiment of step 140 to apportion actual and future savings among payer, facility and practitioner.

In step 302 the formula for apportioning the savings is agreed upon. In the illustrated embodiment, the following parameters of an apportionment formula are determined:

a first fraction of anticipated future savings for payer;

a second fraction of actual cost savings for practitioners' pool;

a third fraction for future payments to practitioners' pool; and

a fourth fraction of practitioners pool for best performers.

In other embodiments, other formulas are used with the same or different parameters or some combination. In some embodiments, one or more of the four above parameters are time dependent and change in different time intervals after the baseline interval. In some embodiments, step 302 of method 300 is performed much earlier than when the actual savings are determined after the second time interval; for example, these parameters are determined during step 102 when it is determined what range of patient conditions are to be improved. In some embodiments, as stated above, step 302 is performed as part of step 240 in FIG. 2.

The first fraction determines what fraction of past savings per case are allocated to the payer in the way of reduced future payments for the particular range of patient conditions. For purposes of illustration, it is assumed that the first fraction is 75% of the prior year's case cost savings. For the example described above in which the new protocols lead to a cost savings of $3,021 per case after three years, the future payments from the payer to the facility are reduced by the first fraction of this amount. Corrections for cost inflation are also factored in to the future payments, using any method known in the art at the time the embodiment is implemented. Thus by the fourth year after the base period, the payer reduces payments per case for DRG549 by $2,266 and increases payments by any agreed upon escalation factors. If it is further assumed that payment during the base and first improvement year were $23,500 per case, the new payments by the payer to the facility are reduced to $21,235 per case—plus any escalation factors for cost inflation and other factors.

In some embodiments, described below, the first fraction ranges from 0% to 90%. Near 90%, the hospital keeps the actual cost savings in the second time interval but turns over most future savings due to the new procedures to the payer. In these embodiments, the new payments by the payer to the facility are reduced by almost the full $3,021 saved—plus any escalation factors for cost inflation and other factors. As shown in a subsequent subsection, a first fraction at or near 100% is not desirable from the hospital or physicians point of view.

The second fraction determines what fraction of actual cost savings are contributed to a pool for practitioners. In an illustrated embodiment, the second fraction is contributed to a physicians pool for only a limited time, e.g., five years. The contributions to the pool for practitioners enables the practitioners to share in the cost savings that lead to the same or better clinical outcomes and thus align their economic incentives with those of the facility. In some embodiments, some or all of the practitioners' pool is paid to the clinical department to which the practitioners belong, in addition to, or instead of, being paid to the practitioners. For purposes of illustration, it is assumed that the second fraction is 25%. For the example described above in which the new protocols lead to a cost savings of $3,021 per case and a total savings of $2,115,000 per year by the third year, the contribution to the practitioners' pool is the second fraction of the actual savings, $2,115,000 over those improvement years. Thus, after the second year, in the illustrated example, the contribution to the practitioner's pool is 25% of $1,460,000, which is equal to $365,000. In some embodiments, described below, the second fraction ranges from 0% to 75% during the first five years of the agreement reached during step 302.

The third fraction determines what fraction of cost savings are made as future contributions to the pool for practitioners, as future payments are made. The contributions to the pool for practitioners enables the practitioners to share in the sustained cost savings that lead to the same or better outcomes and thus further align their economic incentives with those of the facility. The third fraction must be less than the portion of savings in the future payments received by the facility, which is 1 minus the first fraction. For purposes of illustration, it is assumed that the first fraction is 75%, so that the facility portion is 25%; and that the third fraction is 12.5% (half of the facility portion). In some embodiments, some or all of this fraction is paid to the Clinical Departments to which the contributing physicians belong. In some embodiments, the third fraction is 0%.

The fourth fraction determines what fraction of the pool for practitioners is distributed to the practitioners who achieve the target adverse results rate or better. The remainder of the practitioners' pool is distributed to practitioners who show progress toward the target adverse results rate. The distributions from the pool for practitioners reward the individual practitioners who achieve or progress toward the target adverse results rate. For purposes of illustration, it is assumed that the fourth fraction is 60%. In some embodiments, the fourth fraction is based on the percentage of patients treated by the high performing practitioners. Thus, in such embodiments, if the high performing physicians treat 60% of the patients with the RPC, then they receive 60% of the practitioners' pool. For the example described above in which the new protocols lead to a cost savings of $3,021 per case after the third year and the contribution to the practitioner's pool is $529,000; then 60% ($317,000) is distributed to the practitioners who achieve the target adverse results rate of 1.4% or better. The remaining 40% ($212,000) is distributed to practitioners who improve their adverse results rate from the base year to the third improving year (the fourth year). In some embodiments, the fourth fraction ranges from about 50% to about 100% (at the uppermost value of the fourth fraction, all the practitioners' pool is distributed to the best performers who achieve the target ARR or better). The remainder, if any, is distributed to those practitioners who improved their ARR

In step 310, the future payment to the facility per case are reduced by the first fraction of the past cost savings achieved in the most recent time interval. The payment is also adjusted by any escalation factors. For example, as described above, the payments per case for DRG549 from the payer to the hospital for the third year are reduced by 75% of $3,021, which is $2,266.

It is noted that by reducing the payments to the facility by less than 100% (and incorporating any escalation factors), the profit margin of the facility per case increases—providing a good incentive for investing in the improvements during step 120, described above. For example, if the profit margin is 4.3% during the base year, then the original payments are $23,500, as described above. The reduced payments in the third year (assuming no escalation factors) are $21,235 per case as described above, when the costs are $19,472 per case. The profit margin is then 8.3%. Of course some of this 4 percentage point increase in the profit margin is shared with the practitioners (for five years I the example), according to the second fraction (or the third fraction, in some embodiments). For example, when the second fraction is 25%, $529,000 (about one percentage point) is added to the practitioners' pool in the third year. Still, the new reduced payments provide an increase over the 4.3% profit margin before the improvements were made.

In step 312, the facility increases the contribution to the practitioners' pool from future payments by the third fraction of the past cost savings per case. The third fraction is less than one minus the first fraction. In some embodiments, the third fraction is 0% and step 312 is omitted.

In step 320, the practitioners' share of the total actual cost savings is added to the practitioners' pool. This is the second fraction of the total actual cost savings, described above.

In step 330, a fourth fraction of the practitioners' pool is distributed to members of a high performance set of practitioners. For example, 60% of the practitioners' pool of $529,000 is distributed after the third year to the practitioners who are members of the high performance set.

Step 330 includes determining which practitioners are members of the high performance set after the second time interval. Each practitioner who is a member of the high-performance set provides treatment for the particular range of patient health conditions at the particular facility and realizes an adverse results rate for treatment of the particular range of patient health conditions at or below the target adverse results rate.

It is further assumed for purposes of illustration that 5 physicians handle equally the 700 cases of DRG549 at the particular facility (140 cases each); and that they achieve the adverse results rates listed in Table 2 after each of the base and first improvement time intervals.

TABLE 2
Example adverse results rates of physicians who treat a particular range of
patient conditions.

| | | | Percentage |
|---|---|---|---|
| | Base year | Next year | change in |
| physician | mortality rate | mortality rate | mortality rate |
| A | 0.7% | .7% | 0% |
| B | 1.4% | 1% | −29% |
| C | 1.4% | 2.1% | 50% |
| D | 4.3% | 2.1% | −51% |
| E | 8.6% | 6.4% | −26% |

After the second year, only physicians A and B are members of the high-performance set—with mortality rates at or better than the 1.4% target. Thus physicians A and B receive the fourth fraction of the practitioners' pool, equal to $317,000.

In some embodiments the funds are equally distributed to all members. In some embodiments, the funds are weighted by number of cases each physician treated. In some embodiments, the funds are also weighted by the actual adverse results rate, giving more to the practitioner who has a lower adverse results rate. For example, in some embodiments, a weighting factor is used that is 0 above the target rate (e.g., greater than 1.55% mortality rate), 1 for ARR at or near the target rate (e.g., 1.25% to 1.55% mortality rate), 2 for somewhat better than the target rate (e.g., 0.95% to 1.25% mortality rate), 3 for moderately better than the target rate (e.g., 0.55% to 0.95% mortality rate) and 4 for much better than the target rate (e.g., 0.00% to 0.55% mortality rate). In the weighted distribution, physician A has a weight of 3 (3 times the number of cases in some embodiments) and physician B has a weight of 2 (2 times the number of cases in some embodiments). Therefore physician A receives ⅗ of the funds for the high performance group and physician B receives ⅖ of the funds. Thus physician A receives $190,000 and physician B receives $127,000. At 140 cases per physician, physician A receives about $1273 per case and physician B receives about $907 per case, in recognition for achieving good results under the new protocols.

In step 340, a remainder of the practitioners' pool (i.e., a fifth fraction=1−fourth fraction) is distributed to members of an improving set of practitioners. For example, 40% of the practitioners' pool of $529,000 is distributed to the practitioners who are members of the improving set.

Step 340 includes determining which practitioners are members of the improving set after the second time interval. In some embodiments, each practitioner who is a member of the improving set provides treatment for the particular range of patient health conditions at the particular facility and realizes an adverse results rate for treatment of the particular range of patient health conditions above the target adverse results rate but closer to the target adverse results rate after the second time interval than after the first time interval. After the second year, only physicians D and E are members of the improving set—with decreasing mortality rates that remain worse than the 1.4% target. Thus physicians D and E receive the fifth fraction of the practitioners' pool, equal to $212,000

In some embodiments, all improving physicians receive some of the fifth fraction even if they are members of the high performance set.

In some embodiments the funds are equally distributed to all members of the improving set. In some embodiments, the funds are weighted by number of cases each physician treated. In some embodiments, the funds are weighted by the actual improvement in adverse results rate, giving more to the practitioner who has improved an adverse results rate more. For example, in some embodiments, a weighting factor is used that is 0 for little or no improvement (e.g., ARR changes greater than −19%), 0.5 for relatively low improvement (e.g., ARR changes from −20% to −29%), 1.0 for low improvement (e.g., ARR changes from −30% to −39%), 1.5 for moderate improvement (e.g., ARR changes from −40% to −49%), 2.0 for high improvement (e.g., ARR changes from −50% to −59%), 2.5 for very high improvement (e.g., ARR changes from −60% to −69%), and 3.0 for extremely high improvement (e.g., ARR changes at and below −70%). In the weighted distribution, physician B has a weight of 0.5, physician D has a weight of 2 and physician E has a weight of 0.5. Therefore physician B receives 0.5/3, D receives ⅔ of the funds for the high performance group and physician E receives 0.5/3 of the funds. Thus physician B receives $35,000, physician D receives $141,000 and physician E receives $35,000. At 140 cases each, physician B receives about $250 per case, physician D receives about $1000 per case and physician E receives about $250 per case, in recognition for improving results under the new protocols.

### 2.3 Comparison of Two Embodiments with Different Parameter Values for Per-Case Payments

A hospital determines whether or not to enter into such a payment arrangement based on its current and expected situation with respect to that payer for a particular range of patient conditions:

then current payment type: per case, per diem or percent of charges;

then current profitability of that and other contracts for patient condition;

expected target for reduced case cost; and

negotiation of acceptable terms regarding
percentage of cost savings to be shared,
duration of sharing, and
path of payment adjustments in relation to cost reductions.

If the hospital is receiving a case rate of payment at the outset, an alternative mechanism for sharing cost savings may be used. The average payment and percentage of admissions by that payer to that hospital for the readmission of patients within 90 days of discharge due to complications resulting from the first admission for that patient condition are calculated, and in subsequent time periods the hospital and payer share equally in the reduced costs to the payer of readmissions that fall below the original percentage of patients discharged for that condition.

Using financial models and Monte Carlo simulation, realistic net present value is estimated for each of various participants under two embodiments using different values for the fraction parameters. The first set of parameter values, called Model A, offers a recurring reward to the hospital which is reflected as a permanent change in the payment structure. The second set of parameter values, called Model B, offers a one-time reward to the hospital based on the payer's current-year savings while the underlying payment policy and level and ultimate profit margin remains constant.

It is assumed, for purposes of illustration, that if any party expects to experience a negative outcome as measured by their net present value (NPV) of their financial benefit over time, that party will not participate, and none of the stakeholders will realize the potential benefits of performance improvement.

It is determined that the outcome depends upon the existing payment structure—that is, a per diem or per case rate for payment.

These models examine targeted improvements in severity-adjusted clinical outcomes for a specific patient condition, DRG 549 Coronary Artery Bypass Graft surgery (CABG). These embodiments specifically focus on DRG 549 because this is a high cost, high visibility procedure which was also included in the CMS/Premier Pay for Performance (P4P) Demonstration. As shown in Table 1, there are many other patient conditions and procedures which offer similar opportunities for improving clinical outcomes and reducing case costs.

Models A and B call for 3-year periods of planned performance improvement between payers, hospitals and physicians. That is, the improvement period is three years starting after the base period The two models produced similar levels of performance improvement and cost savings. This allowed a comparison of the net present value to each stakeholder under the different models. It is difficult to predict the exact amount of improvements in hospital performance. For certain key variables, a probability distribution was defined instead of making a point estimate, and Monte Carlo simulations were performed to estimate the results.

Both models start at year 0, which is also called the baseline year. The assumptions and variables common to both models, which are different from the extended DRG 549 example discussed earlier, are listed below.

There were three participants: payer (health plan), hospital, and physicians.

At the outset of the project, the hospital had a fixed number (500) of annual admissions for DRG 549549, with a constant growth rate of admissions equal to zero.

At the outset of the project, the hospital received an average case rate payment of $26,000 (or a per diem payment of $2,600 for a 10-day stay for each DRG 549 case), and incurred an average case cost of $25,000 per DRG 549 case. In the following a case is also called an admission, referring to an admission to the hospital.

The hospital invested a set amount for each of the three years. The hospital deducted this amount from the total cost savings before sharing any rewards with physicians.

The physicians also invested a set amount for each of the three years. In addition to the potential for P4P benefits, the hospital may also enjoy collateral benefits, such as increased service volume as a result of the quality investments. However, this value was set to 0, as the goal here was to focus on the direct financial impact of the proposed gainsharing and P4P projects.

The annual present value discount rate was 10%, which does not change from year to year.

In each of the three years following baseline year 0, each physicians had a fixed 80% probability of meeting the quality criteria. The model allows the probability to decrease each year, based on the expectation of diminishing marginal returns. However, this probability decrease was set to zero for the results presented here, meaning that the probability is constant year-by-year.

If the physicians attempted and succeeded in meeting the established quality criteria, then the hospital's quality score consequently improved. A 3% “most likely” amount for the percent improvement of the quality score was assumed, as well as an upper and lower bound of 1% and 5%, respectively (triangular distribution).

If the physicians attempted but failed to meet the established quality criteria, the hospital's quality score still improved, but by less than if the physicians had succeeded. The improvement was assumed to also have a triangular distribution with values of 0%, as a lower bound, 0.5%, as a most likely improvement and 1% as an upper bound.

For each 1% improvement in the quality score, the hospital per admission cost was reduced by a certain percentage. It was assumed that this percentage falls uniformly between two predetermined values: 3% and 8%.

After the conclusion of the 3-year quality improvement demonstration, the hospital continued to pay rewards to the participating physicians or their clinical departments for an additional 5 years.

Model A was designed such that any financial benefits resulting from clinical improvements become structured into the payment scheme indefinitely. For this reason, Model A includes “recurring rewards.” Specific assumptions in Model A included the following.

Beginning in year 1, the hospital and its physicians made the necessary investments in quality improvement and consequently realized a per case cost reduction in DRG 549. Beginning at the onset of the following year, payment per case to the hospital was reduced by the first fraction=75% percent of the amount of the per-case cost reduction.

If the physicians achieved their targets, the hospital shared 50% (second fraction) of the cost savings that resulted from the per-case cost reduction (after subtracting annual investment costs) with the physicians. If not, the hospital contributed this same percentage of the cost savings to the relevant clinical department, not directly to the physicians. For purposes of physician return on investment (ROI) calculation, hospital contributions to the departments count as a fixed percent of direct rewards to physicians. This percentage was initially set to 75%.

In contrast to Model A, Model B was designed such that any financial benefits which result from clinical improvements are shared between stakeholders only once—during the year in which they occur—without changing the original profit margin. Rewards were distributed (separately from routine service payments) at the completion of each year of the demonstration. This model is referred to as “one-time” P4P sharing. Specific assumptions made for model B included the following.

Beginning in year 1, the hospital and its physicians made the necessary investments in quality improvement and consequently realized a per case cost reduction in DRG 549. Beginning the following year, the payer's average per-case hospital payment was reduced by exactly the per-case cost reduction realized by the hospital and its physicians (first fraction=100%). This outcome is based on the premise that as the quality improves and complications are reduced, the case rate of payment for the patient condition and related procedures will fall commensurately.

At the first year's end, the payer rewarded the hospital with a predetermined percentage of the per case-cost reduction. In the examples, the payer received 75% of the first year saving (first fraction=75%). After subsequent years the payer received 100% of the first year savings (first fraction=100%).

If the physicians achieved their targets, then the hospital shared a second fraction of the cost savings with the physicians. Otherwise, the hospital contributed this same percentage (second fraction) of the savings to the relevant clinical department.

As noted, the important distinction between the models is in the structure of payments/rewards. In both models, costs and their consequent reductions were identical. Note that there was a one period time lag (between year 0 and year 1) in both Model A and Model B, representing when the hospital cuts case costs and when the payer cuts associated payments. The hospital reduces case costs in year 1 and the payer reduces per-case payment in year 2. The critical difference between the two models is how payment reduction takes place and by how much.

In Model A, the payment reduction is an agreed upon percentage (first fraction) of the cost reduction. The difference (between the cost reduction in year 1 and payment reduction in year 2) is the amount which the hospital is allowed to keep. This margin functions as a built-in reward.

In Model B, payment reduction is by the full amount (first fraction=100%) of the cost reduction from year to year after a one year period in which the first fraction=75%. The reward to the hospital by the payer is a predetermined percentage of any savings that result from clinical improvements in that year. It is important to note, however, that this reward is separate from the per-case rate of payment.

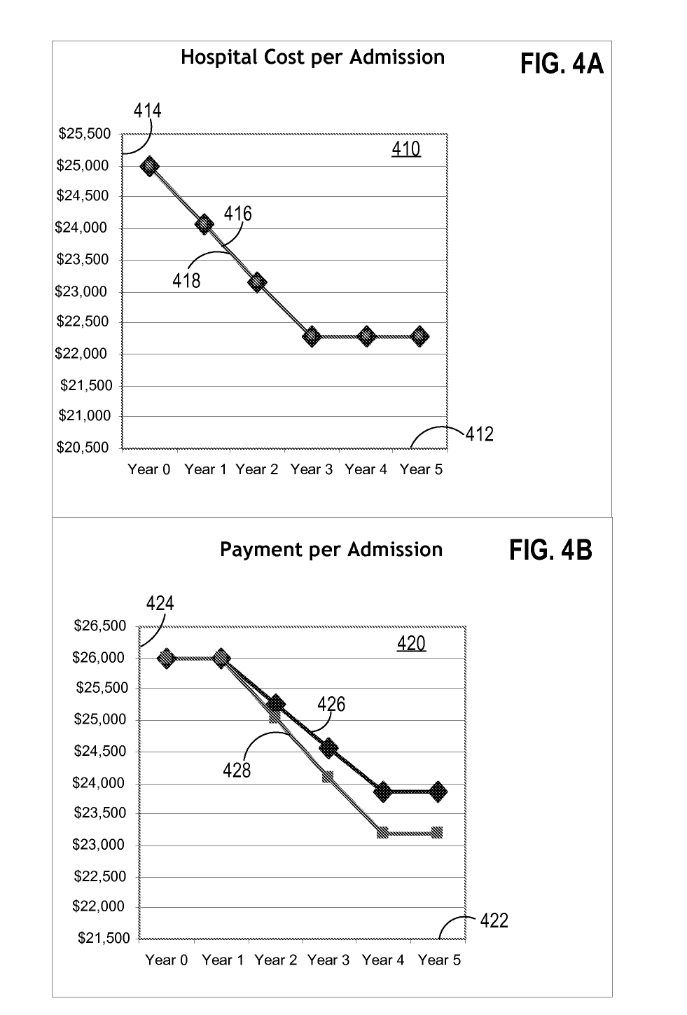

FIG. 4A is a graph 410 that illustrates cost reductions with time, according to two embodiments with per-case rates. The horizontal axis 412 indicates time in years from baseline year (year 0). The vertical axis 414 indicates actual costs per case for DRG 549. Trace 416 indicates the costs over time for Model A. Trace 418 indicates the costs over time for Model B and overlays trace 416. The costs shown for each year are based on a Monte Carlo run for five years.

FIG. 4B is a graph that illustrates reductions in payments per case with time, according to two embodiments with per-case rates. The horizontal axis 422 indicates time in years from base year (year 0). The vertical axis 424 indicates payments per case for DRG 549. Trace 426 indicates the payments over time for Model A. Trace 428 indicates the payments over time for Model B. The payments to the hospital are less for Model B.

To estimate the amount of cost savings and rewards to be shared for each model and each payment case, a Monte Carlo simulation run for five years was used with an expected probability of 80 percent physician success. The results of the simulation over 5 years are shown in Table 3.

TABLE 3
Example expected net present value (NPV) to each stakeholder.

| | Hospital NPV | Physician NPV | Payer NPV | Total |
|---|---|---|---|---|
| Model A | $2,041,877 | $614,347 | $8,297,464 | $10,953,688 |
| Model B | $660,880 | ($64,447) | $10,402,035 | $10,998,468 |
| Difference | ($1,380,997) | ($678,794) | $2,104,571 | $44,780 |
| (B − A) | | | | |

Based on the 5-year NPV summary statistics presented in Table 3, it is easy to see that Model A is preferable to the providers (hospital and physicians), while Model B yields more preferable results for the payer. In fact, Model B offers decidedly negative results for physicians, and only marginal benefits for the hospital. Quality improvements, cost reductions and payment rates per year for each model in the per case payment example are listed in Table 4.

TABLE 4
Example quality, cost and payments over five years.

| | % quality | | Hospital cost per | | | |
|---|---|---|---|---|---|---|
| | improvement | | case | | | |
| | Model | | Model | | Payment per case | |
| Year | A | Model B | A | Model B | Model A | Model B |
| 0 | — | — | $25,000 | $25,000 | $26,000 | $26,000 |
| 1 | 2.50% | 2.51% | $24,057 | $24,062 | $26,000 | $26,000 |
| 2 | 2.51% | 2.50% | $23,153 | $23,159 | $25,265 | $25,025 |
| 3 | 2.51% | 2.51% | $22,277 | $22,277 | $24,553 | $24,085 |
| 4 | 0.00% | 0.00% | $22,277 | $22,277 | $23,856 | $23,176 |
| 5 | 0.00% | 0.00% | $22,277 | $22,277 | $23,856 | $23,176 |

Table 4 shows that while quality improves by 8% and case cost falls by 11%, payment per admission declines by 8% in Model A and by the full amount of the case cost payment, 11%, in Model B. In essence, the payer receives 75% of the cost savings in Model A and 100% of the cost savings in Model B.

While both models offer positive outcomes to the hospital, Model A offers a significantly higher NPV, largely due to the payment adjustments that create long-term sharing of any cost savings that ensue from clinical improvements. In both models throughout year 1 (before any payment reductions are effective), the hospital retains 100 percent of cost savings (and shares this savings with its physicians). Upon striking an agreement of this type with its payer (presumably in year 0), the hospital's motivation to implement immediate clinical improvements is strong, since it keeps all cost savings during the first year of the program.

However, after the first year of the program, the hospital would prefer to enter the setup offered in Model A, not Model B, because Model A allows the hospital to retain more of the cost reductions it achieves. In fact, Model A permanently restructures cost savings into the new payment structure. While Model B still offers a positive outcome (in terms of NPV), it offers far less to the hospital than Model A, and given project uncertainties, the hospital may realize a negative outcome.

Physicians' incentives are largely in line with the hospital's incentives—they prefer Model A. It is also important to note that while Model B still provides a modest return, Model B offers physicians a negative 5-year NPV. Given the opportunity costs incurred by the physicians, this must be interpreted as an unacceptable outcome, especially in light of the fact that they are primarily responsible for the success or failure of any clinical improvement project.

To the payer, Model B offers roughly 25 percent more savings than Model A. In this regard, Model B is more preferable to the payer. However, as noted above, this setup is likely to be a near impossible sell to the hospital and its physicians. This result highlights the fact that payers must genuinely take into consideration the hospital's and physicians' outcome expectations under any P4P structure they endorse and offer for consideration.

### 2.4 Comparison of Two Embodiments with Different Parameter Values for Per-Diem Payments

The per diem payment cases are very important for two reasons. Many, if not most, hospitals are paid by health plans on per diem rates for most kinds of patient conditions and procedures. If a health plan were not willing to offer a hospital an increasing per diem rate as the hospital reduces its length of stay and/or other operating costs and thereby drives up its per diem costs while lowering its per case costs, there may be virtually no middle ground for sufficient sharing of cost savings by the players to embark on performance improvement demonstrations.

The setup and assumptions for the two models in the case of a per diem payment plan are nearly identical to the per-case payment embodiments, described above. The exceptions are as follows.

Payment per day is assumed to be $2,600 per day for an average 10-day length of stay (LOS) at the outset. This effectively means that at the start, the hospital receives on average the same amount per case as it did under the DRG payment structure—that is, $26,000.

Costs per day by day of stay are shown in Table 5 below.

TABLE 5
Example per diem cost breakdown for DRG 549.

| | | Average cost |
|---|---|---|
| Day | Cost per day | through Day |
| 1 | $3,750 | $3,750 |
| 2 | $8,750 | $6,250 |
| 3 | $3,750 | $5,417 |
| 4 | $3,750 | $5,000 |
| 5 | $1,000 | $4,200 |
| 6 | $1,000 | $3,667 |
| 7 | $750 | $3,250 |
| 8 | $750 | $2,938 |
| 9 | $750 | $2,694 |
| 10 | $750 | $2,500 |

As noted above, at the outset of the project (year 0), the hospital's average LOS for DRG 549 is 10 days.

All other variable assumptions are the same as in the per-case payment approach. And once again, both Models A and B include a clinical gain sharing component which produces the same amounts of quality and case cost savings over the same time periods. Notice also that, after day 7, the daily cost levels out at $750 per day. Identical cost savings in this case are based on end-of-stay decreases in LOS. For instance, a decrease in LOS from 10 to 9 days eliminates $750 of case cost.

Model A is designed such that any financial benefits which result from clinical improvements are formally structured into the payment rate for the foreseeable future. Specific assumptions in Model A are shown below.

Beginning in year 1, the hospital and its physicians made the necessary investments in quality improvement and consequently realized a reduction in average LOS and case cost for DRG 549. Beginning at the onset of the following year (year 2), payment per diem to the hospital is increased by a fixed percentage for each percent reduction in LOS. This embodiment represents a different formula for apportionment than in embodiments described earlier, because not every day in the LOS has the same cost. Thus the future payments are not a fixed fraction of the future savings in dollars but a fixed fraction of the future savings in LOS. In other embodiments, the increase in the per diem rate is just sufficient to reduce payment per case by 75% of the actual case cost reduction in that year.

If the physicians achieve their targets, the hospital shares a percentage of the decrease in aggregate per case costs (after subtracting annual implementation costs) with the physicians (the second fraction). Otherwise, the hospital contributes the same percentage (the second fraction) of the rewards to the clinical department, not directly to the physicians.

Here again, model B is designed such that any financial benefits which result from clinical improvements are shared between stakeholders without formally changing the original payment scheme. Rewards paid at the end of each year are distributed separately from routine per diem payments and only for the first year in which the cost reduction took place. Assumptions specific to Model B are as follows.

Beginning in year 1, the hospital and its physicians made the necessary investments in quality improvement and consequently realized a reduction in average LOS for DRG 549. Throughout all years, (1-3) payment continues to be made on a per diem basis.

At each year's end, the payer rewards the hospital with a predetermined percentage of the payment reduction which corresponds to the decrease in LOS. In the previously described embodiments this percentage is 100%. In some embodiments, this percentage is less than 100% for at least some time periods.

If the physicians achieved their targets, the hospital shared a percentage (second fraction) of the case cost savings with the physicians. Otherwise, the hospital contributes the same percentage (second fraction) of the savings to the department.

As noted, the important difference between the models is in the structure of payments/rewards. In both models, costs and their corresponding reductions are identical. Once more, the driving distinction between Model A and B is how payment reduction takes place and by how much in relation to case costs.

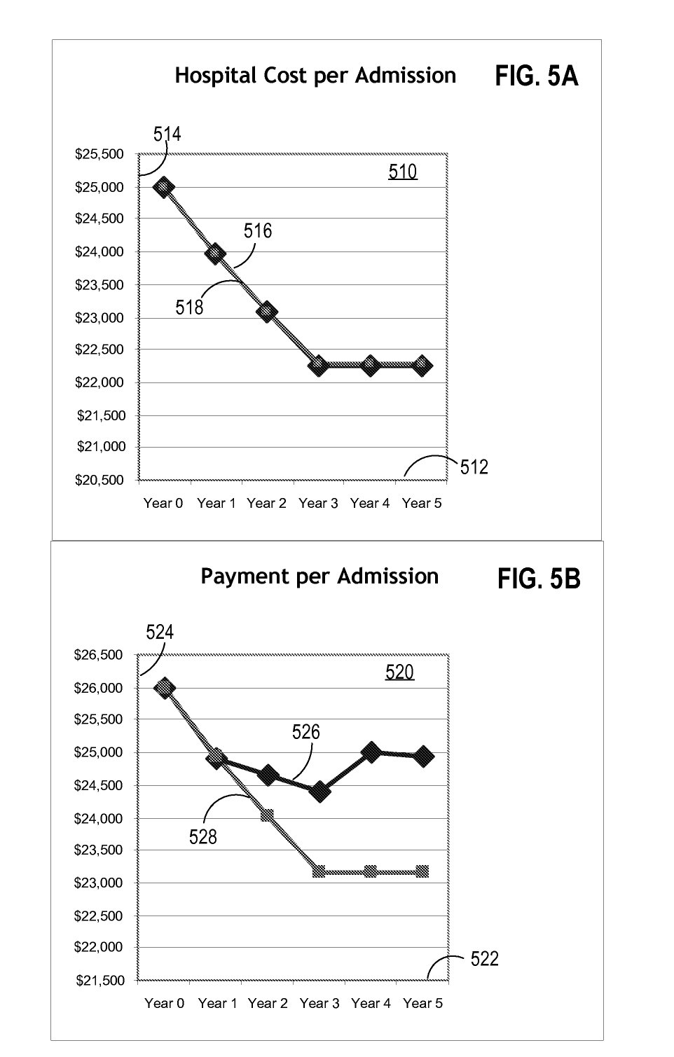

FIG. 5A is a graph that illustrates cost reductions with time, according to two embodiments with per diem rates at the outset. The horizontal axis 512 indicates time in years from baseline year (year 0). The vertical axis 514 indicates actual costs per case for DRG 549. Trace 516 indicates the costs over time for Model A. Trace 518 indicates the costs over time for Model B and overlays trace 516. The cost reductions are associated with shortened LOS.

FIG. 5B is a graph that illustrates reductions in payments per case with time, according to two embodiments with per diem rates at the outset. Though costs per case go down, costs per diem may increase. The horizontal axis 522 indicates time in years from base year (year 0). The vertical axis 524 indicates payments per case for DRG 549. Trace 526 indicates the payments over time for Model A. Trace 528 indicates the payments over time for Model B. The payments to the hospital are less for Model B

Notice that there is a one period time lag (between year 0 and year 1) in both Model A and Model B, as also noted in the previous section, representing a delay between when the hospital cuts LOS and when the payer increases payments per diem for reductions in LOS. The hospital reduces LOS in year 1 and the payer increases per diem payment in year 2. As noted above, the driving difference in the two models is in payment. In Model B, payments to the hospital decrease correspondingly as costs steadily decline. In Model A, however, payment per admission to the hospital actually rises after the third year.

The 5-year NPV summary statistics are presented in Table 6.

TABLE 6
Example expected net present value (NPV) to each stakeholder for per
diem payments.

| | Hospital NPV | Physician NPV | Payer NPV | Total |
|---|---|---|---|---|
| Model A | $4,724,916 | $1,000,513 | $5,269,090 | $10,994,519 |
| Model B | ($563,979) | $275,991 | $11,435,495 | $11,147,506 |
| Difference | ($5,288,895) | ($724,522) | $6,166,405 | $152,988 |
| (B − A) | | | | |

Based on Table 6, it is easy to see that Model A is largely preferable to the providers (hospital and physicians), while Model B yields more preferable NPV results to the payer. In fact, Model B offers decidedly negative results for hospitals, which would not likely agree to such an apportionment. It is clear that there is no incentive for the hospital to participate in Model B in the per diem payment case, because the hospital would incur the requisite investment costs of the demonstration, and, in turn, suffer from constant per diem payment rates while its average cost per day increased.

Based on the NPV results in Table 4, the hospital experienced strong positive gains in Model A and negative returns in Model B. In both models, the average LOS fell from 10 days to 5.82 days. But, in Model A, the fall in LOS generated strong improvements in the hospital's margin per admission for DRG 549. In Model B the margin per admission steadily declined during each year of the agreement. This decline is not sufficiently offset by direct one-time rewards payments from the payer to yield a positive NPV, which concludes that Model B is an unacceptable structure according to the hospital's perspective

The physicians' incentives are largely similar to those of the hospital—they prefer Model A. Both models offer positive gains to the physicians, but Model A offers significantly more. Given that physicians are expected to hit their targets 80 percent of the time, it is not likely that they would ever opt for a setup similar to Model B.

Net present value accruing to the payer under both models is positive. However, it is clear that Model B offers the payer more than twice the savings of Model A, which is mostly at the expense of the hospital. While the payer would obviously prefer a setup similar to Model B, it is unlikely that it could ever reach an agreement of this nature with any hospitals capable of analyzing the pros and cons of such an offer.

Under the CABG example embodiments shown here (and for other clinical areas), there are opportunities for hospitals to save millions in costs, depending on hospital size and case volume. However, the active participation of the hospital's physicians is desirable for achieving these cost savings in a clinical gain sharing approach. The widespread adaptation of these embodiments likely depends on investments made by these two participants in combination with a willing health plan. Furthermore, to actively engage in P4P or gain sharing, each participant is likely to demand an expected ROI which is attractive and deemed equitable in relation to those of the other participants.

According to this analysis, the one-time reward model (Model B) is an embodiment of the invention (with first fraction=100%) that offers insufficient financial returns to the hospital and physicians, while allowing the health plan to retain virtually all benefits. This embodiment is less desirable because it fails to align financial incentives sufficiently across all stakeholders. This suggests that sharing in the short term, followed by a return to the existing payment policies, is not likely to be acceptable to hospitals and their physicians.

The recurring rewards model (Model A) is an embodiment of the invention (with first fraction=75% for all future time intervals) that offers substantial potential to deliver attractive financial gains to both the hospital and physicians, while still preserving comparable levels of benefits for the health plan to the one time model. A primary reason the providers are likely to find such a setup attractive is because the disbursement of realized cost savings is directly embedded in the payment system, and therefore continues into the future. Hospitals will therefore expect a provision in their contracts that the payment rate/case cost differential will be maintained, at least in part, in the future.

Negotiations of this nature would likely involve direct communication between payers and hospitals on an individual basis. That is, every hospital would likely determine its own separate term discussions. Moreover, most, if not all, clinical and financial reporting would likely come from the hospital's information systems, subject to audit on the part of the health plan or a neutral third party.

The financial incentive approach to gain sharing preferably involves long-term partnerships between participants, rather than one-time sharing accords. This is because the accommodation of these agreements typically involves the sharing of information between participants. Therefore, a partnership based on trust helps align stakeholder financial incentives in a manner that likely offers lasting benefits.

### 3. Software Embodiments

Some or all of the steps of the above methods may be implemented in software. In some steps implemented in software, information determined is received as input data. Any method may be used to receive this data. For example, in various embodiments, the data is included as a default value in software instructions, is received as manual input from a network administrator on a local node or a remote node of a network, is retrieved from a local file or database, or is sent from a different node on the network, either in response to a query or unsolicited, or the data is received using some combination of these methods.

### 4. Computer Hardware Overview

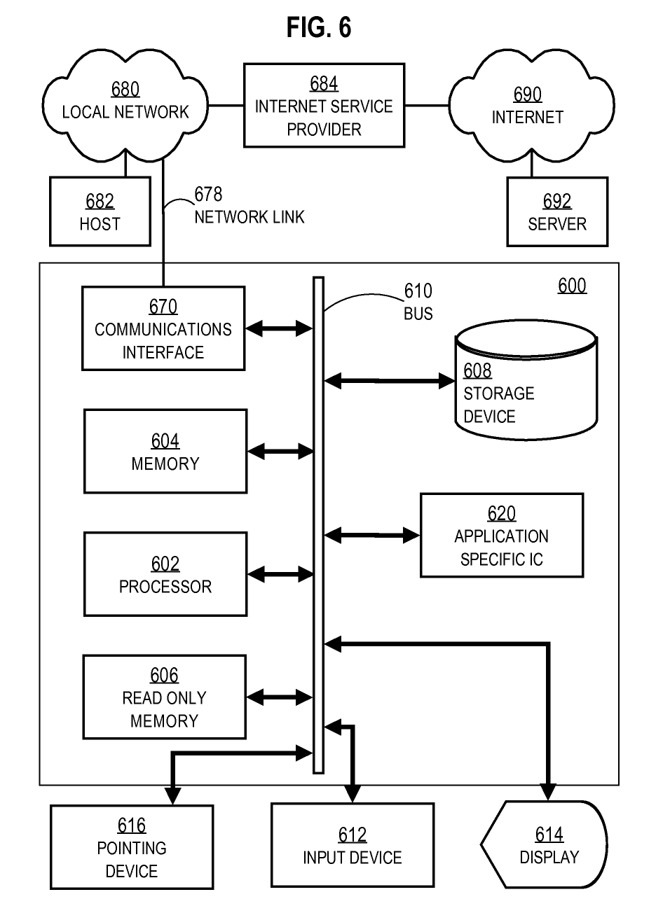

FIG. 6 is a block diagram that illustrates a computer system 600 upon which an embodiment of the invention may be implemented. Computer system 600 includes a communication mechanism such as a bus 610 for passing information between other internal and external components of the computer system 600. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit). A sequence of binary digits constitutes digital data that is used to represent a number or code for a character. A bus 610 includes many parallel conductors of information so that information is transferred quickly among devices coupled to the bus 610. One or more processors 602 for processing information are coupled with the bus 610. A processor 602 performs a set of operations on information. The set of operations include bringing information in from the bus 610 and placing information on the bus 610. The set of operations also typically include comparing two or more units of information, shifting positions of units of information, and combining two or more units of information, such as by addition or multiplication. A sequence of operations to be executed by the processor 602 constitute computer instructions.

Computer system 600 also includes a memory 604 coupled to bus 610. The memory 604, such as a random access memory (RAM) or other dynamic storage device, stores information including computer instructions. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of computer instructions. The computer system 600 also includes a read only memory (ROM) 606 or other static storage device coupled to the bus 610 for storing static information, including instructions, that is not changed by the computer system 600. Also coupled to bus 610 is a non-volatile (persistent) storage device 608, such as a magnetic disk or optical disk, for storing information, including instructions, that persists even when the computer system 600 is turned off or otherwise loses power.

Information, including instructions, is provided to the bus 610 for use by the processor from an external input device 612, such as a keyboard containing alphanumeric keys operated by a human user, or a sensor. A sensor detects conditions in its vicinity and transforms those detections into signals compatible with the signals used to represent information in computer system 600. Other external devices coupled to bus 610, used primarily for interacting with humans, include a display device 614, such as a cathode ray tube (CRT) or a liquid crystal display (LCD), for presenting images, and a pointing device 616, such as a mouse or a trackball or cursor direction keys, for controlling a position of a small cursor image presented on the display 614 and issuing commands associated with graphical elements presented on the display 614.

In the illustrated embodiment, special purpose hardware, such as an application specific integrated circuit (IC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends and receives electrical, acoustic or electromagnetic signals, including infrared and optical signals, that carry information streams, such as digital data. Such signals are examples of carrier waves.

The term computer-readable medium is used herein to refer to any medium that participates in providing information to processor 602, including instructions for execution. Such a medium may take many forms, including, but not limited to, non-volatile media, volatile media and transmission media. Non-volatile media include, for example, optical or magnetic disks, such as storage device 608. Volatile media include, for example, dynamic memory 604. Transmission media include, for example, coaxial cables, copper wire, fiber optic cables, and waves that travel through space without wires or cables, such as acoustic waves and electromagnetic waves, including radio, optical and infrared waves. Signals that are transmitted over transmission media are herein called carrier waves.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read.

Network link 678 typically provides information communication through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690. A computer called a server 692 connected to the Internet provides a service in response to information received over the Internet. For example, server 692 provides information representing video data for presentation at display 614.

The invention is related to the use of computer system 600 for implementing the techniques described herein. According to one embodiment of the invention, those techniques are performed by computer system 600 in response to processor 602 executing one or more sequences of one or more instructions contained in memory 604. Such instructions, also called software and program code, may be read into memory 604 from another computer-readable medium such as storage device 608. Execution of the sequences of instructions contained in memory 604 causes processor 602 to perform the method steps described herein. In alternative embodiments, hardware, such as application specific integrated circuit 620, may be used in place of or in combination with software to implement the invention. Thus, embodiments of the invention are not limited to any specific combination of hardware and software.

The signals transmitted over network link 678 and other networks through communications interface 670, which carry information to and from computer system 600, are exemplary forms of carrier waves. Computer system 600 can send and receive information, including program code, through the networks 680, 690 among others, through network link 678 and communications interface 670. In an example using the Internet 690, a server 692 transmits program code for a particular application, requested by a message sent from computer 600, through Internet 690, ISP equipment 684, local network 680 and communications interface 670. The received code may be executed by processor 602 as it is received, or may be stored in storage device 608 or other non-volatile storage for later execution, or both. In this manner, computer system 600 may obtain application program code in the form of a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to an infra-red signal, a carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

### 5. Extensions and Alternatives

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for determining payment to a particular health care facility for health care delivery, comprising the steps of:
determining target adverse results rate for treatment of a particular range of patient health conditions;
determining first actual cost at a particular health care facility for treatment of the particular range of patient health conditions during a first time interval;
determining first adverse result rate at the particular health care facility after treatment for the particular range of patient health conditions during the first time interval;
determining second actual cost at the particular health care facility for treatment of the particular range of patient health conditions during a second time interval after an end of the first time interval;
determining second adverse result rate at the particular health care facility after treatment for the particular range of patient health conditions during the second time interval;
determining whether the second actual cost prorated per case of the particular range of patient health conditions is less than the first actual cost prorated per case and whether the second adverse result rate is not farther from the target adverse result rate than is the first adverse result rate; and
if it is determined that the second actual cost prorated per case is less than the first actual cost prorated per case and that the second adverse result rate is not farther from the target adverse result rate, then reducing future payments per case to the particular health care facility for treatment of the particular range of patient health conditions after the second time interval based on a first fraction of the difference between the first actual cost prorated per case and the second actual cost prorated per case.

2. The method as recited in claim 1, further comprising, if it is determined that the second actual cost prorated per case is greater than the first actual cost prorated per case, then performing the steps of:
determining whether the total cost of readmissions within 90 days from discharge of patients treated for the particular range of patient conditions is less than during the first time interval; and
if it is determined that the total cost of readmissions within 90 days from discharge of patients treated for the particular range of patient conditions is less than during the first time interval, then increasing future payments per case to the hospital by a readmission adjustment fraction of the amount of readmission payments to the hospital.

3. The method as recited in claim 1, further comprising, if it is determined that the second actual cost prorated per case is less than the first actual cost prorated per case and that the second adverse result rate is not farther from the target adverse result rate, then performing the steps of:
determining a contribution to a practitioners' pool based on a second fraction of a difference between the second actual cost prorated per case and the first actual cost prorated per case; and
distributing the practitioners' pool to at least one practitioner who provides treatment for the particular range of patient health conditions at the particular facility.

4. The method as recited in claim 1, further comprising, if it is determined that the second actual cost prorated per case is less than the first actual cost prorated per case and that the second adverse result rate is not farther from the target adverse result rate, then performing the step of:
determining future contributions to a practitioners' pool for treatment of the particular range of patient health conditions after the second time interval based on a third fraction of the difference between the first actual cost prorated per case and the second actual cost prorated per case; and
distributing the practitioners' pool after the second time interval to at least one practitioner who provides treatment for the particular range of patient health conditions at the particular facility,
wherein the third fraction is not greater than one minus the first fraction.

5. The method as recited in claim 3, said step of distributing the practitioners' pool to at least one practitioner who provides treatment for the particular range of patient health conditions at the particular facility further comprising the steps of:
determining a high-performance set of zero or more practitioners, wherein each practitioner who is a member of the high-performance set provides treatment for the particular range of patient health conditions at the particular facility and realizes an adverse results rate for treatment of the particular range of patient health conditions at or below the target adverse results rate; and
distributing to the practitioners who are members of the high performance set after the second time interval a fourth fraction of the practitioners' pool.

6. The method as recited in claim 5, further comprising:
determining an improving set of zero or more practitioners, wherein each practitioner who is a member of the improving set provides treatment for the particular range of patient health conditions at the particular facility and realizes an adverse results rate for treatment of the particular range of patient health conditions above the target adverse results rate but closer to the target adverse results rate after the second time interval than after the first time interval; and
distributing to the practitioners who are members of the improving set after the second time interval a fifth fraction of the practitioners pool,
wherein the fifth fraction is equal to one minus the fourth fraction.

7. The method as recited in claim 1, wherein the first fraction is in a range from about 25 percent to about 75 percent.

8. The method as recited in claim 3, wherein the second fraction is in a range from about 10 percent to about 50 percent.

9. The method as recited in claim 4, wherein the third fraction is about 50 percent.

10. The method as recited in claim 5, wherein the fourth fraction is at least about 60 percent.

11. The method as recited in claim 5, wherein the fourth fraction is based on a ratio of a first number of cases for the particular range of patient health conditions at the particular facility treated by the high-performance set and a second number of cases for the particular range of patient health conditions at the particular facility.

12. The method as recited in claim 1, further comprising determining the particular range of patient health conditions, comprising the steps of:
determining a plurality of ranges of patient health conditions;
for each range of patient health conditions,
determining a performance difference between a low adverse results rate for treatment by an upper percentile of practitioners who have the lowest rate of adverse results and medium adverse results rate for treatment by an average practitioner, and
determining a cost difference by subtracting cost per case for treatment by the upper percentile of practitioners from cost per case for treatment by the average practitioner; and
selecting, from among the plurality of ranges of patient health conditions, the particular range of patient health conditions for which the low adverse results rate is associated with a positive cost difference.

13. A method as recited in claim 12, said step of determining a plurality of ranges of patient health conditions further comprising determining a single range of patient health condition based on a single medical code and a limited degree of severity, wherein severity of patient conditions is a measure of adverse expected outcome due to complicating factors including other collateral conditions suffered by the patient, age, weight or conditioning, or simultaneous procedures.

14. A method as recited in claim 13, wherein the single medical code is one of a single diagnosis related group (DRG) code or an International Classification of Diseases (ICD-10-CM) code, or an All Payer Refined DRG (APR-DRG) code.

15. A method as recited in claim 1, said steps of determining actual cost at the particular health care facility comprising subtracting from total cost at the particular health care facility indirect costs of the particular health care facility, whereby costs unrelated to direct treatment of the patient are substantively removed from the measure of cost.

16. A method as recited in claim 12, said step of subtracting cost per case for treatment by the upper percentile of practitioners from cost per case for treatment by the average practitioner further comprising determining a cost per case by subtracting, from total cost per case of the range of patient health conditions, indirect costs of the health care facility where the patient was treated, whereby costs unrelated to direct treatment of the patient are substantively removed from the measure of cost per case.

17. A method as recited in claim 1, wherein adverse results rate includes at least one of a rate of mortality or a rate of complications or a rate of readmission.

18. A computer-readable medium carrying one or more sequences of instructions for determining payment to a particular health care facility for health care delivery, wherein execution of the one or more sequences of instructions by one or more processors causes the one or more processors to perform the steps of:
determining target adverse results rate for treatment of a particular range of patient health conditions;
determining first actual cost at a particular health care facility for treatment of the particular range of patient health conditions during a first time interval;
determining first adverse result rate at the particular health care facility after treatment for the particular range of patient health conditions during the first time interval;
determining second actual cost at the particular health care facility for treatment of the particular range of patient health conditions during a second time interval after an end of the first time interval;
determining second adverse result rate at the particular health care facility after treatment for the particular range of patient health conditions during the second time interval;
determining whether the second actual cost prorated per case of the particular range of patient health conditions is less than the first actual cost prorated per case and whether the second adverse result rate is not farther from the target adverse result rate than is the first adverse result rate; and
if it is determined that the second actual cost prorated per case is less than the first actual cost prorated per case and that the second adverse result rate is not farther from the target adverse result rate, then determining reduced future payments per case to the particular health care facility for treatment of the particular range of patient health conditions after the second time interval based on a first fraction of the difference between the first actual cost prorated per case and the second actual cost prorated per case.

19. A computer-readable medium as recited in claim 18, wherein, if it is determined that the second actual cost prorated per case is greater than the first actual cost prorated per case, then execution of the one or more sequences of instructions further causes the one or more processors to perform the steps of:
determining whether the total cost of readmissions within 92 days from discharge of patients treated for the particular range of patient conditions is less than during the first time interval; and
if it is determined that the total cost of readmissions within 92 days from discharge of patients treated for the particular range of patient conditions is less than during the first time interval, then increasing future payments per case to the hospital by a readmission adjustment fraction of the amount of readmission payments to the hospital.

20. A computer-readable medium as recited in claim 18, wherein, if it is determined that the second actual cost prorated per case is less than the first actual cost prorated per case and that the second adverse result rate is not farther from the target adverse result rate, then execution of the one or more sequences of instructions further causes the one or more processors to perform the steps of:
determining a contribution to a practitioners' pool based on a second fraction of a difference between the second actual cost prorated per case and the first actual cost prorated per case; and
distributing the practitioners' pool to at least one practitioner who provides treatment for the particular range of patient health conditions at the particular facility.

21. A computer-readable medium as recited in claim 18, wherein, if it is determined that the second actual cost prorated per case is less than the first actual cost prorated per case and that the second adverse result rate is not farther from the target adverse result rate, then execution of the one or more sequences of instructions further causes the one or more processors to perform the steps of:
determining future contributions to a practitioners' pool for treatment of the particular range of patient health conditions after the second time interval based on a third fraction of the difference between the first actual cost prorated per case and the second actual cost prorated per case; and
distributing the practitioners' pool after the second time interval to at least one practitioner who provides treatment for the particular range of patient health conditions at the particular facility,
wherein the third fraction is not greater than one minus the first fraction.

22. A computer-readable medium as recited in claim 20, said step of distributing the practitioners' pool to at least one practitioner who provides treatment for the particular range of patient health conditions at the particular facility further comprising the steps of:
determining a high-performance set of zero or more practitioners, wherein each practitioner who is a member of the high-performance set provides treatment for the particular range of patient health conditions at the particular facility and realizes an adverse results rate for treatment of the particular range of patient health conditions at or below the target adverse results rate; and
distributing to the practitioners who are members of the high performance set after the second time interval a fourth fraction of the practitioners' pool.

23. A computer-readable medium as recited in claim 22, wherein execution of the one or more sequences of instructions further causes the one or more processors to perform the steps of:
determining an improving set of zero or more practitioners, wherein each practitioner who is a member of the improving set provides treatment for the particular range of patient health conditions at the particular facility and realizes an adverse results rate for treatment of the particular range of patient health conditions above the target adverse results rate but closer to the target adverse results rate after the second time interval than after the first time interval; and
distributing to the practitioners who are members of the improving set after the second time interval a fifth fraction of the practitioners pool,
wherein the fifth fraction is equal to one minus the fourth fraction.

24. A computer-readable medium as recited in claim 18, wherein the first fraction is in a range from about 25 percent to about 75 percent.

25. A computer-readable medium as recited in claim 20, wherein the second fraction is in a range from about 10 percent to about 50 percent.

26. A computer-readable medium as recited in claim 21, wherein the third fraction is about 50 percent.

27. A computer-readable medium as recited in claim 19, wherein the fourth fraction is at least about 60 percent.

28. A computer-readable medium as recited in claim 22, wherein the fourth fraction is based on a ratio of a first number of cases for the particular range of patient health conditions at the particular facility treated by the high-performance set and a second number of cases for the particular range of patient health conditions at the particular facility.

29. A computer-readable medium as recited in claim 18, wherein execution of the one or more sequences of instructions further causes the one or more processors to perform the step of determining the particular range of patient health conditions, comprising the steps of:
determining a plurality of ranges of patient health conditions;
for each range of patient health conditions,
determining a performance difference between a low adverse results rate for treatment by an upper percentile of practitioners who have the lowest rate of adverse results and medium adverse results rate for treatment by an average practitioner, and
determining a cost difference by subtracting cost per case for treatment by the upper percentile of practitioners from cost per case for treatment by the average practitioner; and
selecting, from among the plurality of ranges of patient health conditions, the particular range of patient health conditions for which the low adverse results rate is associated with a positive cost difference.

30. A computer-readable medium as recited in claim 29, said step of determining a plurality of ranges of patient health conditions further comprising determining a single range of patient health condition based on a single medical code and a limited degree of severity, wherein severity of patient conditions is a measure of adverse expected outcome due to complicating factors including other collateral conditions suffered by the patient, age, weight or conditioning, or simultaneous procedures.

31. A computer-readable medium as recited in claim 30, wherein the single medical code is one of a single diagnosis related group (DRG) code or an International Classification of Diseases (ICD-10-CM) code, or an All Payer Refined DRG (APR-DRG) code.

32. A computer-readable medium as recited in claim 18, said steps of determining actual cost at the particular health care facility comprising subtracting from total cost at the particular health care facility indirect costs of the particular health care facility, whereby costs unrelated to direct treatment of the patient are substantively removed from the measure of cost.

33. A computer-readable medium as recited in claim 29, said step of subtracting cost per case for treatment by the upper percentile of practitioners from cost per case for treatment by the average practitioner further comprising determining a cost per case by subtracting, from total cost per case of the range of patient health conditions, indirect costs of the health care facility where the patient was treated, whereby costs unrelated to direct treatment of the patient are substantively removed from the measure of cost per case.

34. A computer-readable medium as recited in claim 18, wherein adverse results rate includes at least one of a rate of mortality or a rate of complications or a rate of readmission.

35. An apparatus for determining payment to a particular health care facility for health care delivery, comprising:
means for determining target adverse results rate for treatment of a particular range of patient health conditions;
means for determining first actual cost at a particular health care facility for treatment of the particular range of patient health conditions during a first time interval;
means for determining first adverse result rate at the particular health care facility after treatment for the particular range of patient health conditions during the first time interval;
means for determining second actual cost at the particular health care facility for treatment of the particular range of patient health conditions during a second time interval after an end of the first time interval;
means for determining second adverse result rate at the particular health care facility after treatment for the particular range of patient health conditions during the second time interval;
means for determining whether the second actual cost prorated per case of the particular range of patient health conditions is less than the first actual cost prorated per case and whether the second adverse result rate is not farther from the target adverse result rate than is the first adverse result rate; and
means for reducing future payments per case to the particular health care facility for treatment of the particular range of patient health conditions after the second time interval based on a first fraction of the difference between the first actual cost prorated per case and the second actual cost prorated per case, if it is determined that the second actual cost prorated per case is less than the first actual cost prorated per case and that the second adverse result rate is not farther from the target adverse result rate.
